(19) United States
(12) Patent Application Publication
(10) Pub. No.: US 2010/0014816 A1
(43) Pub. Date: Jan. 21, 2010

(54) SECURING MODULE FOR AN OPTICAL FIBER CONNECTION MODULE

(75) Inventors: Ulrich Hetzer, Berlin (DE); Ferenc Nad, Berlin (DE)

Correspondence Address: MERCHANT & GOULD PC, P.O. BOX 2903, MINNEAPOLIS, MN, 55402-0903, US

(73) Assignee: ADC GmbH, Berlin (DE)

(21) Appl. No.: 12/489,859

(22) Filed: Jun. 23, 2009

(30) Foreign Application Priority Data
Jun. 24, 2008 (DE) 10 2008 029 802.6

(51) Int. Cl. G02B 6/36; G02B 6/00

(52) U.S. Cl. 385/92; 385/137

(57) ABSTRACT

The invention relates to a securing module (20) for an optical fiber connection module, comprising a plate-shaped element (21), the plate-shaped element (21) being formed with two spring-loaded levers (22), which are each mounted in such a way that they are capable of rotating about a rotary spindle (25), the levers (22) each having a grip region (23) and a fastening region (24), the fastening region (24) having a C-shaped holding means (29) in cross section.

This application claims benefit of Ser. No. 10 2008 029 802.6, filed 24 Jun. 2008 in Germany and which application is incorporated herein by reference. To the extent appropriate, a claim of priority is made to the above disclosed application.

### BACKGROUND

The invention relates to a securing module for an optical fiber connection module which is fastened on round bars.

Optical fiber connection modules often have a front panel with receptacles for couplings or adapters for receiving optical fiber pieces from both sides (from the inside and the outside). At least one optical fiber cable is fed at least from the rear side of the connection module and is then split in the interior of the housing, the individual fibers then being inserted with a plug into the rear side of the couplings or adapters (instead of an optical fiber cable, a plug can also be provided). The cable feed can also take place via a multifiber plug combination (female plug, adapter, male plug), from which wires with plugs then directly emerge. The problem arises as to how the plugs on the rear side of the couplings or adapters are intended to be cleaned since they can only be reached with difficulty.

One problem with optical fiber connection modules which are fastened on round bars is the fact that the optical fiber connection modules are now only secured slightly when the round bars are pulled down in order to move the optical fiber connection module into a convenient working position. If a plurality of optical fiber connection modules are arranged one above the other, the lower optical fiber connection modules support an upper optical fiber connection module which has been withdrawn. However, there is no such securing means for the lowermost optical fiber connection module.

### SUMMARY

The invention is based on the technical problem of providing a securing module for an optical fiber connection module in order to secure optical fiber connection modules which are fastened on round bars more effectively.

In this regard, the securing module for an optical fiber connection module comprises a plate-shaped element, the plate-shaped element being formed with two spring-loaded levers, which are each mounted in such a way that they are capable of rotating about a rotary spindle, the levers each having a grip region and a fastening region, the fastening region having a C-shaped holding means in cross section.

Preferably, the grip region of a lever is arranged against a dedicated spring.

Further preferably, in each case two wedge-shaped surface elements are arranged on the inner surfaces of the holding means, with the result that, despite tolerances provided for the round bars and holding means, a fixed connection is ensured in a reliable manner.

In a further preferred embodiment, a radially peripheral web is arranged on the outer surface of the holding means and increases the stability of the fastening means.

### BRIEF DESCRIPTION OF THE DRAWINGS

The invention will be explained in more detail below with reference to a preferred exemplary embodiment. In the figures:

FIG. 1 shows a housing of an optical fiber connection module in a perspective front view in a first position,

FIG. 2 shows the housing in a perspective rear view in the first position,

FIG. 3 shows the housing in a perspective rear view in a second position,

FIG. 4 shows a view from below of a securing module,

FIG. 5 shows a perspective plan view of the securing module,

FIG. 6 shows a perspective detail illustration of a fastening means, and

FIG. 7 shows a perspective view from below of three optical fiber connection modules on round bars with a securing module.

### DETAILED DESCRIPTION

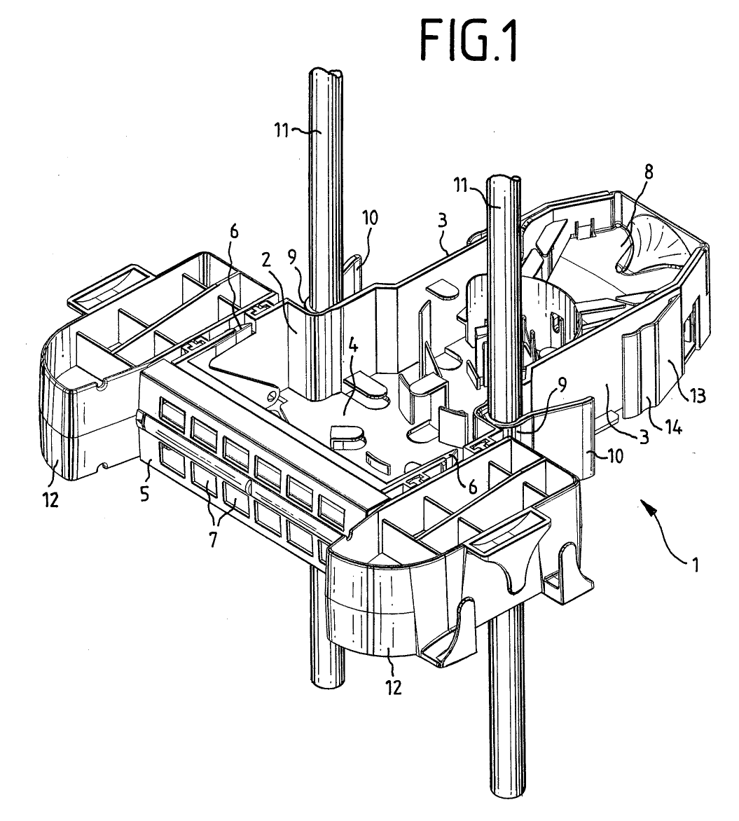

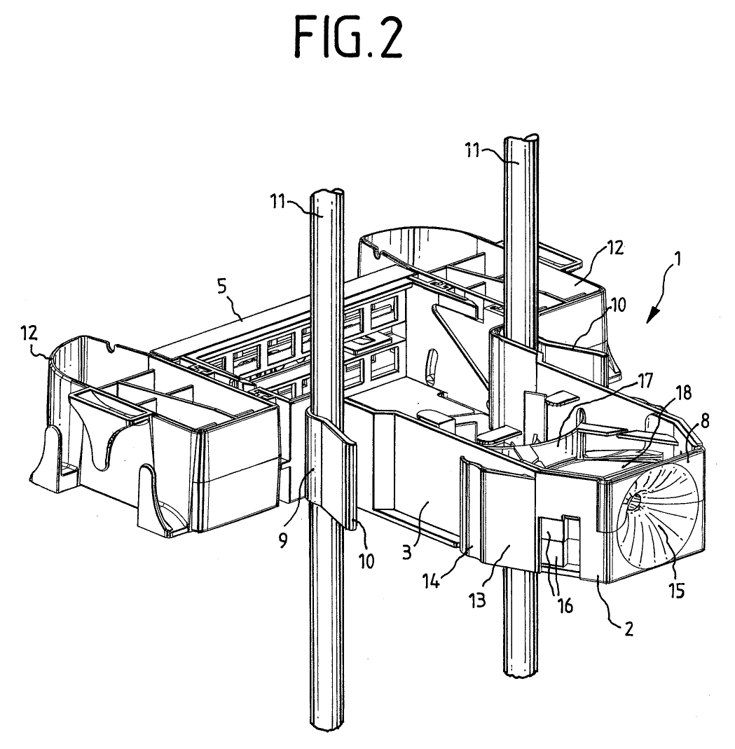

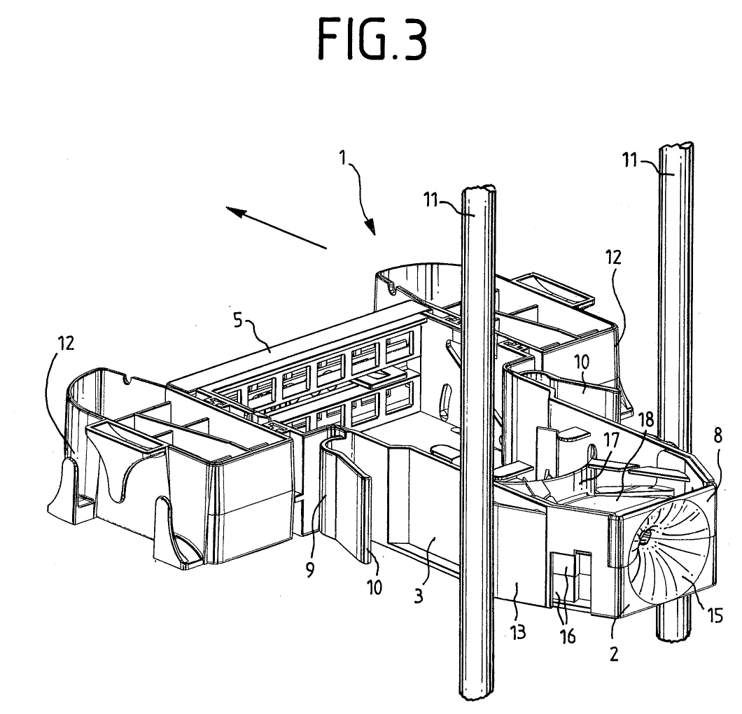

FIG. 1 illustrates a housing 1 of an optical fiber connection module. The housing 1 is made completely of plastic. The housing 1 has a first housing part or base part 2, which has side walls 3 and a bottom surface 4. Cable guides 12 are latched laterally onto the base part 2. A front panel 5 is latched onto the front side and can be unlatched by means of latching clips 6, it being possible for the front panel 5 to be lifted up in the unlatched position so that it can then be pivoted downward. The front panel 5 also has receptacles 7 for couplings and adapters, which are not illustrated. A further housing part 8 is latched onto the rear side. Two first fastening means 9 are arranged on the side walls 3 of the base part 2, and a feed lever 10 is arranged on the end side of said fastening means. The first fastening means 9 are in this case in the form of arcuate snap-action elements, which, in the first position illustrated, engage around two round bars 11 and thus fasten the housing 1. Furthermore, two second fastening means 13 are arranged on the side walls 3, which fastening means 13 are in the form of resilient lugs. In this case, the resilient lugs have depressions 14 for accommodating the round bars 11 if the optical fiber connection module is moved into the second position (see FIG. 3). The further housing part 8 forms, together with the base part 2, a radius-shaping cable outlet 15 on the rear side of the housing 1. This cable outlet 15 is preferably dimensioned in such a way that two microdistribution cables can be passed through. The microdistribution cable(s) is/are then guided in a strain relief means which is hidden by the housing part 8. The strain relief means is arranged directly in front of the cable outlet 15. Furthermore, a receptacle comprising latching hooks and bearing elements for one or two fan-out elements is arranged on the bottom surface 4, in which fan-out elements the cables are split into individual fibers, which are then preferably passed on, enveloped by protective sleeves, in the housing 1. Then, plugs are arranged at the ends of the optical fibers, which plugs are then plugged into the rear side of the couplings in the receptacles 7. Furthermore, the housing 8 has elements 16 for closing openings for multiple plug combinations, the openings being arranged on the two side walls 3 of the base part 2 and each being capable of accommodating two plugs. If these plugs are intended to be used instead of the microdistribution cables, the elements 16 are severed at the desired breaking points. When using only one plug, only the lower element 16 is severed. Wires are passed into the housing 1 via these plugs, and in this case the strain relief means is then preferably likewise severed at a desired breaking point in this housing. On the upper side, the housing part 8 has a radius 17, with the result that a winding plane 18 for wires is formed between the radius 17 and the rear wall of the housing 1, with the result that the individual wires with different reserve lengths can be stored, the wires with a shorter reserve length being guided closer to the radius 17. These reserve lengths are necessary in order to follow up with wire length when the front panel is pivoted. Furthermore, the wire lengths are typically equal in length, but different wire lengths are required depending on the position of the couplings in the front panel 5. This can be compensated for by the different reserve lengths. In this case, there is also a clear separation of reserve lengths of cables and wires, the cables being wound beneath the housing part 8 and the wires being wound on the winding plane 18.

In particular in order to clean the plugs which have been plugged into the rear side of the couplings in the receptacles 7, the housing 1 is withdrawn forward (in the arrow direction, see FIG. 3). In order to simplify this operation, the feed levers 10 are pressed outward. If the housing 1 is then drawn further out, it ultimately snaps in on the second fastening means 13, which is illustrated in FIG. 3.

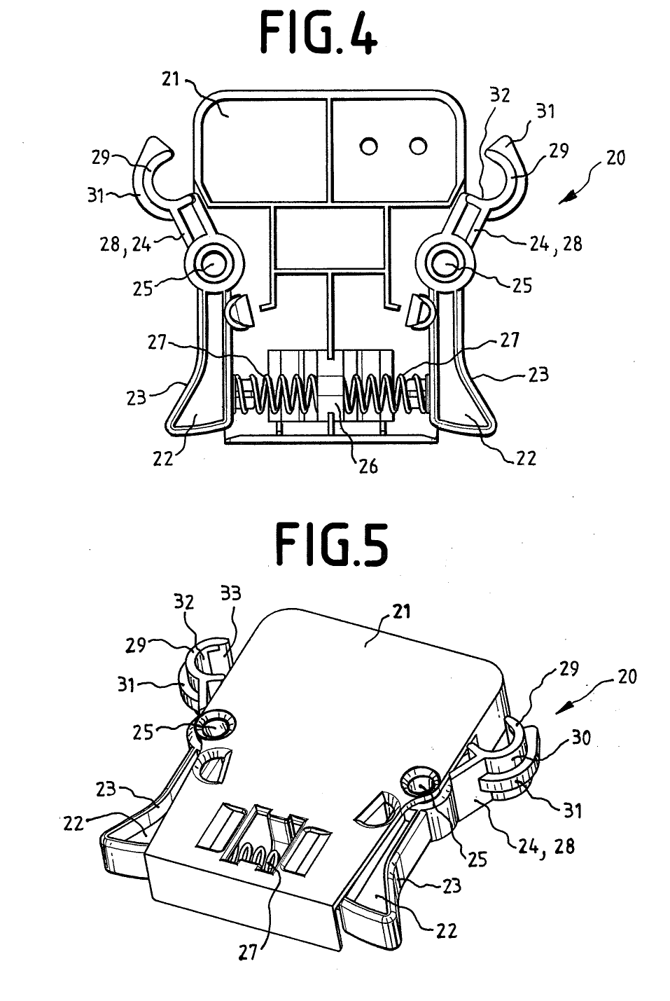

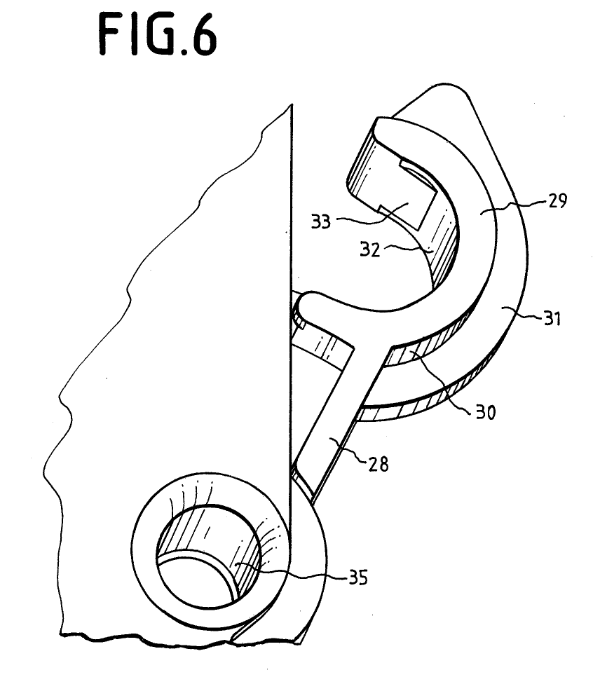

FIGS. 4 and 5 illustrate a securing module 20. The securing module 20 comprises a plate-shaped element 21. Two levers 22, which each have a grip region 23 and a fastening region 24, are arranged on the plate-shaped element 21. The levers 22 are mounted in such a way that they are capable of rotating via rotary spindles 25, the rotary spindles 25 separating the grip region 23 and the fastening region 24 from one another. A stop 26 is arranged on the lower side of the plate-shaped element, and in each case one spring 27 is arranged to the left and right of said stop 26, which spring 27 in each case strikes against the grip region 23 of the respective lever 22 on the side opposite the stop 26. The fastening region 24 comprises a lever arm 28 and a holding means 29. The holding means 29 has a substantially C-shaped cross section, with a centrally and radially peripheral web 31 being arranged on the outer surface 30. The holding means 29 has two wedge-shaped surfaces 33 (see FIG. 6) on the inner surface 32, which wedge-shaped surfaces 33 are each arranged in the region of the open C shape, with only one surface (33) being shown in FIG. 6. Furthermore the bearing 35 of the lever 22 for the rotary spindle 25 is illustrated. The wedge-shaped surface 33 in this case protrudes with respect to the inner radius of the C shape, the wedge-shaped surface 33, as illustrated in FIG. 6, not needing to extend over the full width of the holding means 29. In order to now latch the securing module 20 onto the round bars 11, the levers 22 are moved toward one another in the grip region 23 against the springs 27. This means that, as a result of the rotation about the rotary spindle 25, the holding means 29 is rotated further outward and can thus be pushed against the round bars 11. By means of the levers 22 being released on the grip region 23, the springs 27 and the holding means 29 are quickly released back toward the inside, the wedge-shaped surfaces 33 of a holding means 29 fixedly clamping in the associated round bar 11. The securing module 20 is in this case fastened on the round bars 11 in such a way that the upper side of the plate-shaped element 21 is positioned below the lowermost optical fiber connection module.

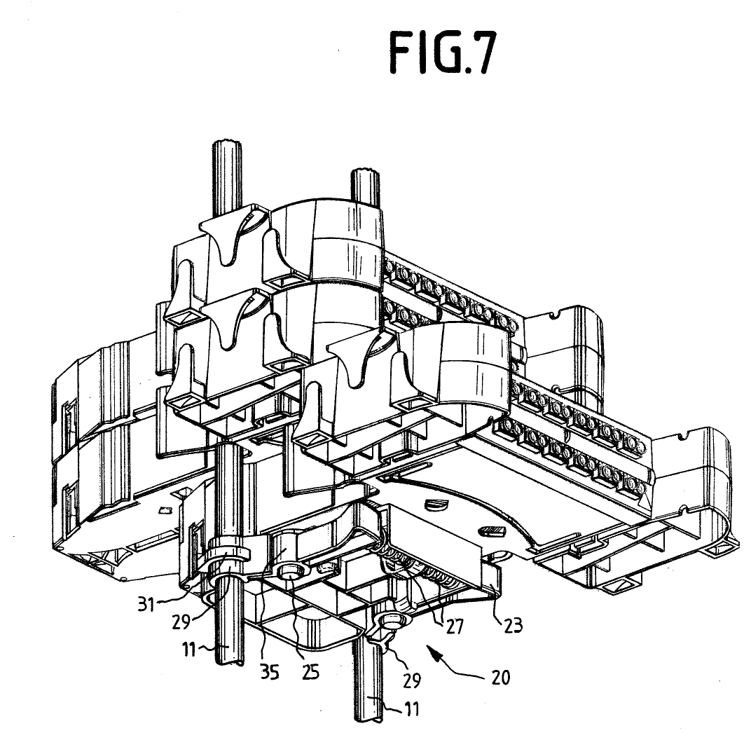

If the lowermost optical fiber connection module, as illustrated in FIG. 7, is now pushed into the second position, the securing module 20 supports it, with the result that the optical fiber connection module cannot tip away even if pressure is applied to the optical fiber connection module from the front. FIG. 7 illustrates the couplings 34 of the optical fiber connection module.

### LIST OF REFERENCE SYMBOLS

1 Housing
2 Base part
3 Side walls
4 Bottom surface
5 Front panel
6 Latching clips
7 Receptacles
8 Housing part
9 First fastening means
10 Feed lever
11 Round bars
13 Second fastening means
14 Depressions
15 Cable outlet
16 Elements
17 Radius
18 Winding plane
20 Securing module
21 Plate-shaped element
22 Lever
23 Grip region
24 Fastening region
25 Rotary spindle
26 Stop
27 Spring
28 Lever arm
29 Holding means
30 Outer surface
31 Web
32 Inner surface
33 Wedge-shaped surface
34 Couplings
35 Bearing

1. A securing module for an optical fiber connection module, comprising a plate-shaped element, the plate-shaped element being formed with two spring-loaded levers, which are each mounted in such a way that they are capable of rotating about a rotary spindle, the levers each having a grip region and a fastening region, the fastening region having a C-shaped holding means in cross section.

2. The securing module as claimed in claim 1, wherein the grip regions of the levers are each arranged against a spring.

3. The securing module as claimed in claim 1, wherein in each case two wedge-shaped surface elements are arranged on the inner surfaces of the holding means.

4. The securing module as claimed in claim 1, wherein in each case one radially peripheral web is arranged on the outer surfaces of the holding means.
